(19) United States
(12) Patent Application Publication
(10) Pub. No.: US 2024/0058635 A1
(43) Pub. Date: Feb. 22, 2024

(54) FIRE DETECTION AND SUPPRESSION SYSTEM

(71) Applicant: Tyco Fire Products LP, Cranston, RI (US)

(72) Inventors: Shubhankar Roychoudhury, Thane (IN); Subodh Dilip Bahadure, Singapore (SG); Sujitkumar Vishwakarma, Dombivli East (IN)

(73) Assignee: Tyco Fire Products LP, Cranston, RI (US)

(21) Appl. No.: 18/450,841

(22) Filed: Aug. 16, 2023

(30) Foreign Application Priority Data
Aug. 19, 2022 (SG) 10202250784U

(51) Int. Cl. A62C 37/36; A62C 99/00; A62C 3/00

(52) U.S. Cl. CPC A62C 37/04; A62C 99/009; A62C 37/36; A62C 3/006

(57) ABSTRACT

A system includes an image capture device, a fire extinguisher, and one or more processors. The image capture device is to detect one or more images of a premise. The one or more processors are to receive an indication of a fire in the premise, process, responsive to receiving the indication of the fire, the one or more images to determine that the fire meets at least one criteria of being hazardous, and activate the fire extinguisher responsive to the determination that the fire meets the at least one criteria.

### CROSS-REFERENCE TO RELATED APPLICATIONS

The present application claims the benefit of and priority to Singapore Patent Application No. 10202250784U, filed Aug. 19, 2022, the disclosure of which is incorporated herein by reference in its entirety.

### BACKGROUND

A Fire Detection and Suppression System (FDSS) for a building can be or include a system of devices configured to control, monitor, and manage equipment in or around a building or building area to detect and suppress fires. A FDSS may include, for example, but not limited to, a fire alerting system, a fire suppression system, fire extinguishing system, or any other system that is capable of managing building fire safety functions or devices, or any combination thereof.

### SUMMARY

At least one aspect relates to a system. The system can include a fire control panel system that includes one or more sensors to detect fire. The system can include a closed-circuit television (CCTV) system for acquiring an image of a flame of the fire. The system can include one or more processors to perform edge detection on the image of the flame in order to detect whether the fire is a hazardous fire or a non-hazardous fire. The system can include an electric extinguisher which is activated in case the fire detected is a hazardous fire.

At least one aspect relates to a method. The method can include detecting a fire based on one or more sensors. The method can include acquiring an image of a flame of the fire using an image acquisition system. The method can include performing edge detection and flame analysis on the acquired image in order to detect whether the fire is a hazardous fire or a non-hazardous fire. The method can include activating an electric fire extinguisher in case the fire detected is a hazardous fire.

At least one aspect relates to a system. The system can include an image capture device, a fire extinguisher, and one or more processors. The image capture device can detect one or more images of a premise. The one or more processors can receive an indication of a fire in the premise, process, responsive to receiving the indication of the fire, the one or more images to determine that the fire meets at least one criteria of being hazardous, and activate the fire extinguisher responsive to the determination that the fire meets the at least one criteria.

At least one aspect relates to a system. The system can include one or more processors to sample a signal from a fire control panel to identify an indication of a fire in a premise, activate, responsive to receiving the indication of the fire, an image capture device to retrieve one or more images of the premise, classify, according to the one or more images, the fire as being hazardous, and activate at least one of an extinguisher or an alarm responsive to the classification of the fire as being hazardous.

At least one aspect relates to a method. The method can include sampling, by one or more processors, a signal from a fire control panel to identify an indication of a fire in a premise. The method can include activating, by the one or more processors responsive to receiving the indication of the fire, an image capture device to retrieve one or more images of the premise. The method can include classifying, according to the one or more images, the fire as being hazardous. The method can include activating at least one of an extinguisher or an alarm responsive to classifying the fire as being hazardous.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example of a block diagram of an FDSS.

FIG. 2 depicts an example of an electric extinguisher system.

FIG. 2A depicts an example of a sound frequency generator.

FIG. 3 depicts an example of a CCTV system.

FIG. 4 depicts an example of a fire control panel system.

FIG. 5 depicts an example of a computing system.

FIGS. 6A-6D show examples of user configurable real time dashboards provided by a cloud enterprise manager of a computing system.

FIG. 7 depicts a user configurable real time dashboard that presents a health summary of an FDSS.

FIG. 8 depicts a flow diagram of a method of controlling an FDSS.

FIG. 9 depicts a use-case example of installation and implementation of various components of an FDSS.

### DETAILED DESCRIPTION

Before turning to the figures, which illustrate certain examples, it is noted that the present disclosure is not limited to the details or methodology set forth in the description or illustrated in the figures. The terminology used herein is for the purpose of description only and should not be regarded as limiting.

The present disclosure relates generally to the field of fire detection systems. More particularly, the present disclosure relates to fire detection and suppression systems (FDSSs).

A FDSS can be used to detect a fire or fire indicators on a premise, to include residential and commercial premises. The FDSS can use either smoke detectors or temperature sensors as fire detectors. The detection of fire in FDSSs may be based on detection of smoke or temperature, such as to cause an alarm to sound in case a fire is detected so that the premise can be evacuated as early as possible or so that other measures can be taken.

There are many applications, for example, but not limited, commercial kitchen systems, where it is useful to differentiate between fire used for useful functions, such as cooking, from hazardous fire. As an example, in a commercial kitchen, stoves can be used to provide flames and/or fires intermittently and/or continuously during operating hours of the commercial kitchen. It can be challenging for FDSSs to accurate differentiate between such fires (e.g., non-hazardous fires) and hazardous fires. For example, FDSSs can be susceptible to false alarms or nuisance alarms, and may be ineffective at early detection of hazardous fires (e.g., detecting an indication of a fire that has a likelihood of becoming a hazardous if an intervention is not performed) depending on the fire type.

Systems, apparatuses, and methods in accordance with the present disclosure can enable an FDSS to provide an accurate detection of hazardous fire (e.g., to differentiate hazardous and non-hazardous or otherwise useful fires). The FDSS can accurately identify and differentiate hazardous fire from non-hazardous fire. The FDSS can allow for edge computing capabilities to accurately identify hazardous fire. The FDSS can allow for efficient, reliable, accurate, and early fire detection, thereby, preventing false alarms or nuisance alarms.

For example, an FDSS can include an image capture device, a fire extinguisher, and one or more processors. The image capture device can detect one or more images of a premise. The one or more processors can receive an indication of a fire in the premise, process, responsive to receiving the indication of the fire, the one or more images to determine that the fire meets at least one criteria of being hazardous, and activate the fire extinguisher responsive to determining that the fire meets the at least one criteria. By processing the images to determine whether the fire is hazardous (e.g., subsequent to receiving the indication of the fire, such as from a fire control panel), such as by using edge detection or other computer vision or machine learning models, the FDSS can accurately distinguish hazardous fires from useful or otherwise non-hazardous fires in the premise, avoiding false alarms or false activation of extinguishers.

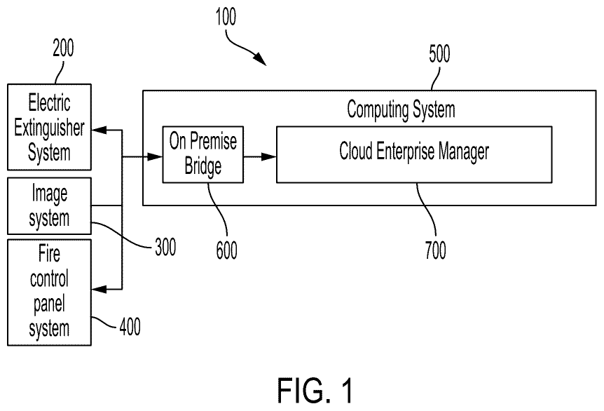

FIG. 1 depicts an example of a fire detection and suppression system (FDSS) 100. The FDSS 100 can include one or more of an extinguisher system 200 (e.g., electric extinguisher system), an image capture (e.g., closed circuit television (CCTV)) system 300, a fire control panel system 400, and/or a computing system 500. The extinguisher system 200, image capture system 300, and fire control panel system 400 can be connected to the computing system 500. The computing system 500 can provide enhanced computing capabilities to the FDSS 100.

The extinguisher system 200, image capture system 300, and fire control panel system 400 can be communicatively coupled to each other and to the computing system 500 (e.g., using various wired and/or wireless communication electronics). For example, the communication among the extinguisher system 200, image capture system 300, fire control panel system 400, and computing system 500 may be wired and/or may be wireless.

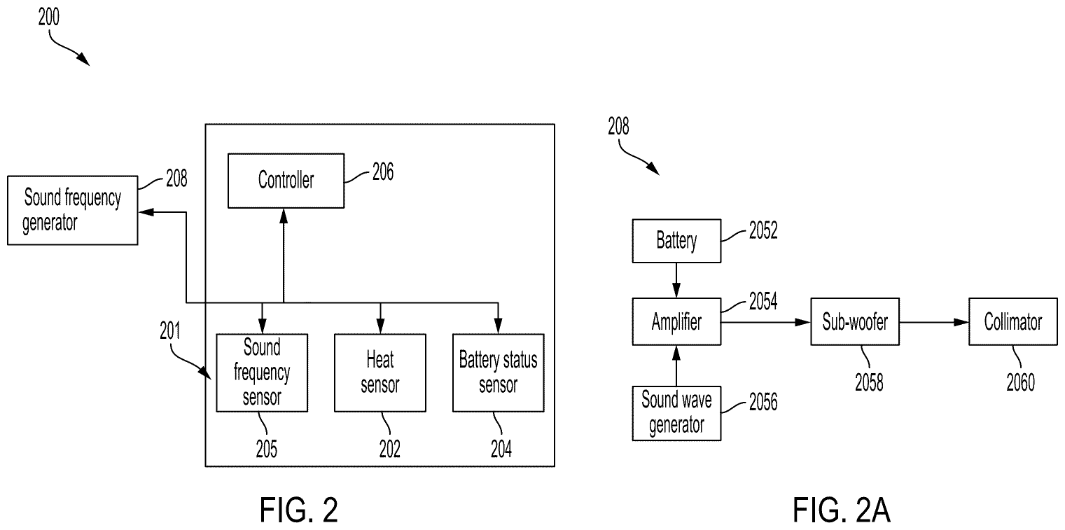

FIG. 2 depicts an example of the extinguisher system 200. The extinguisher system 200 can extinguish or suppress fire. For example, the extinguisher system 200 can output any one or more of acoustic, fluid-based, and/or chemical outputs for addressing a fire condition responsive to detection of a fire condition (e.g., responsive to detection of a hazardous fire by the FDSS 100 or a component thereof).

The extinguisher system 200 can include one or more sensors 201 (e.g., sensors 202, 204, 205). The sensors 201 can detect one or more inputs related to various attributes of the extinguisher system 200. For example, the extinguisher system 200 can include at least one of a heat sensor 202 and a battery status sensor 204. The sensors 201 can output an indication of a respectively detected input and/or attribute, such as to provide a signal to controller 206 indicative of the detected input and/or attribute.

The heat sensor 202 can detect a heat level of a battery (e.g., battery 2052 described with reference to FIG. 2A) of the extinguisher system 200. The battery status sensor 204 can detect a charging level of the battery of the extinguisher system 200. The heat sensor 202 and the battery status sensor 204 can be arranged in various portions of the extinguisher system 200. The heat sensor 202 and the battery status sensor 204 can be arranged outside of the extinguisher system 200.

The extinguisher system 200 can include a sound frequency sensor 205, a controller 206, and a sound frequency generator 208. The controller 206 can include one or more processors and memory. The processor may be a general purpose or specific purpose processor, an application specific integrated circuit (ASIC), one or more field programmable gate arrays (FPGAs), a group of processing components, or other suitable processing components. The processor may be configured to execute computer code or instructions stored in memory (e.g., fuzzy logic, etc.) or received from other computer readable media (e.g., CDROM, network storage, a remote server, etc.) to perform one or more of the processes described herein. The memory may include one or more data storage devices (e.g., memory units, memory devices, computer-readable storage media, etc.) configured to store data, computer code, executable instructions, or other forms of computer-readable information. The memory may include random access memory (RAM), read-only memory (ROM), hard drive storage, temporary storage, non-volatile memory, flash memory, optical memory, or any other suitable memory for storing software objects and/or computer instructions. Various components of the FDSS 100, including the controller 206, can be implemented as a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof. The memory may include database components, object code components, script components, or any other type of information structure for supporting the various activities and information structures described in the present disclosure. The memory may be communicably connected to the processor via the processing circuit and may include computer code for executing (e.g., by processor) one or more of the processes described herein. The memory can include various modules (e.g., circuits, engines) for completing processes described herein.

The sound frequency generator 208 can be arranged inside of the extinguisher system 200, or can be arranged outside of the extinguisher system 200. The sound frequency generator 208 can generate a sound (e.g., sound wave, pressure wave, audio output) having at least one frequency (e.g., as described further with reference to FIG. 2A). The sound frequency generator 208 can generate the sound to address a fire condition.

The controller 206 can control the frequency of the sound generated by the sound frequency generator 208. The controller 206 can transmit a control signal that includes frequency information to the sound frequency generator 208. The frequency information can indicate the at least one frequency of the sound to be generated by the sound frequency generator 208. The frequency information can include amplitude, intermittency, periodicity, or other parameters of the sound to be generated by the sound frequency generator 208. The sound frequency generator 208 can generate the sound having the at least one sound frequency responsive to receiving the control signal.

The sound frequency sensor 205 can detect the at least one sound frequency generated by the sound frequency generator 208. The sound frequency sensor 205 can transmit a sound detection signal indicative of the detected at least one frequency to the controller 206.

The controller 206, responsive to receiving the sound detection signal, can verify whether the detected at least one sound frequency generated by the sound frequency generator 208 is as per the frequency information (e.g., matches the at least one frequency of the control signal provided to the sound frequency generator 208). The controller 206 can output a verification signal indicative of whether the detected at least one sound frequency matches the at least one frequency of the frequency information, such as to the on-premise bridge 600 or various other components of the FDSS 100 or communicatively coupled with the FDSS 100. For example, in case the generated sound frequency is not as per the frequency information, the controller 206 may inform the on-premise bridge 600 by sending a signal.

As depicted in FIG. 2, the extinguisher system 200 can be implemented as an acoustic extinguisher. The extinguisher system 200 can be or include any suitable extinguisher, for example, but not limited to, a chemical extinguisher, a mechanical extinguisher, an electromechanical, or any combination thereof. The extinguisher system 200 can include a sprinkler. The extinguisher system 200 can be one of water-based fire suppression system, chemical foam suppression system, pneumatic heat detection tube, pressurized gas system, foam deluge systems, acoustics-based suppression system, or any combination thereof.

Referring to FIG. 2A, the sound frequency generator 208 can include at least one of a battery 2052, an amplifier 2054, a sound wave generator 2056, a sub-woofer 2058, and a collimator 2060. The sound frequency generator 208 is powered by the battery 2052. The sound frequency generator 208 can be powered by an external power supply and/or the battery 2052 can be connected to the external power supply.

The sound wave generator 2056 and the amplifier 2054 can receive the frequency information from the controller 206 via the control signal. The sound wave generator 2056 generates the sound to have the at least one frequency (and/or other parameters, such as amplitude) as indicated by the control signal. The amplifier 2054 can amplify the generated sound frequency as per the frequency information. The sub-woofer 2058 can produce the amplified sound frequency. The collimator 2060 can control (e.g., modify according to information retrieved from the control signal) at least one of an intensity or a direction of the amplified sound frequency to extinguish or suppress the fire.

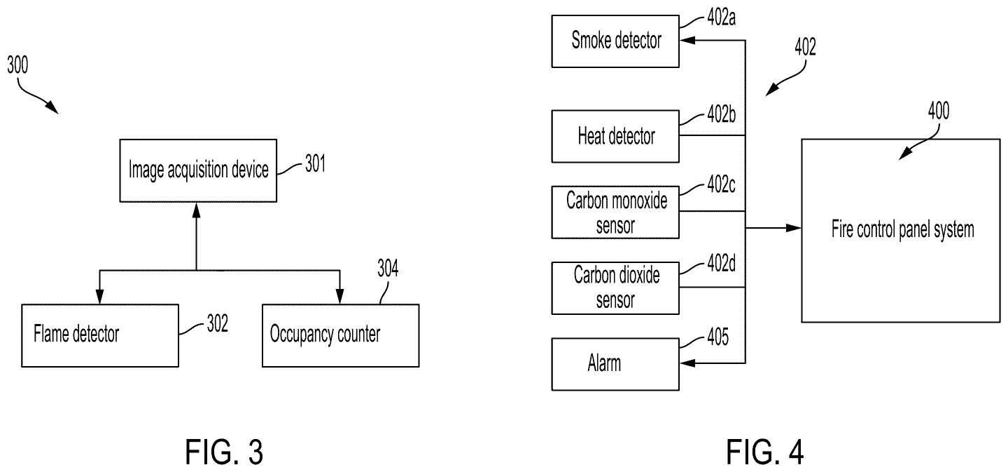

FIG. 3 depicts an example of an image capture system 300. The image capture system 300 can include an image acquisition device 301. The image acquisition device 301 can be and/or include any device capable of acquiring image data, such as a camera, a video recorder, a scanner, a mobile telephone, a tablet computing device, an infrared imaging device (e.g., a thermal imaging device), and/or any other device that can acquire image data. The image acquisition device 301 can include a monocular camera and/or a binocular camera. The image acquisition device 301 can include a visible light camera and/or a thermal imaging camera. The image acquisition device 301 can include a charge-coupled device (CCD), a complementary metal-oxide-semiconductor (CMOS) sensor, an N-type metal-oxide-semiconductor (NMOS), a contact image sensor (CIS), and/or any other image sensor.

The image capture system 300 can capture image data. The image data can include any data representative of one or more images, such as one or more pixel values (e.g., gray values, intensities, color components, luminous, etc. of one or more pixels of an image), timing information, location data, etc. For example, timing information may include a date, a time instant, a time period, etc. on which the image data is acquired. For example, the location data may include one or more coordinates related to one or more image acquisition devices that are configured to acquire the image data (e.g., a latitude coordinate, a longitude coordinate, etc. of the image acquisition devices). The image data can include a still image, a moving image (e.g., a video frame), a thermal image (e.g., a thermal still image, a thermal video frame, etc.), and/or any other image. The image data can be of any of various sizes and/or shapes. For example, an image can be a frame, a field, or any suitable portion of a frame or a field, such as a slice, a block, a macroblock, a set of macroblocks, a coding tree unit (CTU), a coding tree block (CTB), etc.

The image capture system 300 can include one or more processors, memory, speakers, and/or microphone (not shown) to perform any of various image capture or processing operations, including computer vision operations. The image capture system 300 can include a flame detector 302. The flame detector 302 can include any one or more algorithms, functions, logic, routines, computer code, machine learning models, rules, heuristics, or various combinations thereof to perform functions including detecting a flame of a fire or one or more characteristics of the flame and/or the fire, such as to classify the detected fire as being a hazardous fire or a non-hazardous fire. The flame detector 302 can process image data captured by the image capture system 300 to perform various such detection operations. The image capture system 300 can use various parameters of the image acquisition device 301, such as focal length, exposure, etc., to perform detection operations.

For example, the flame detector 302 can process image data (and can also use parameters of the image acquisition device 301) such as position and/or temperature information (e.g., temperature data or color (e.g., wavelength) data representative of temperature) to detect the one or more characteristics. The flame detector 302 can detect characteristics such as size (e.g., flame area), rate of growth, temperature, average temperature, or various combinations thereof according to the image data.

The flame detector 302 can include one or more unsupervised and/or supervised machine learning models to detect the one or more characteristics and/or determine whether the image data is indicative of a hazardous or non-hazardous fire. For example, the flame detector 302 can include any of various machine learning models, such as neural networks, clustering algorithms, regressions, or various combinations thereof. The flame detector 302 can be trained using examples of image data labeled with characteristics, including but not limited to indications of whether the image data represents hazardous fires or non-hazardous fires. The flame detector 302 can detect image processing features for flame detection, such as shapes, edges, or boundaries of image data representative of flames in order to determine the characteristics.

For example, the flame detector 302 can detect a flame area of a potential fire based on the image data. The flame area detection can allow the FDSS 100 to determine whether the fire is a hazardous fire or a non-hazardous fire. Responsive to determining that the flame area is greater than a threshold, such as a predetermined flame area threshold, the flame detector 302 can determine that the fire is a hazardous fire (or, responsive to determining that the flame area is less than the predetermined flame area threshold, determine that the fire is a non-hazardous fire). The threshold can be user-defined, or can be determined by the flame detector 302 (e.g., can be a threshold implemented by a machine learning model of the flame detector 302).

The occupancy counter 304 can detect a count of people in a premise where fire is detected. The occupancy counter 304 can determine the count of people based on the image captured by the image acquisition device 301. The occupancy counter 304 can include, for example, any of various image processing functions that can determine the count of people responsive to detecting people (e.g., shape or other object data representative of people) in the premise. The occupancy counter 304 can determine the count of people based on occupancy sensors, carbon dioxide emission, proximity sensors, or any other suitable method thereof. The count of people detection helps in notifying people in the premise about the hazardous fire. For example, the FDSS 100 can perform notification operations while the count of people (e.g., for the premise in which the hazardous fire is detected) is greater than zero. In case of hazardous fire, the occupancy counter 304 continues the detection of count of people unless the premise is evacuated.

FIG. 4 depicts an example of a fire control panel system 400. The fire control panel system 400 can detect a fire, an indication of a fire, or a hazard. The fire control panel system 400 can include one more sensors or detectors, for example, but not limited to, sensors 402 such as smoke detector 402a, heat detector 402b, carbon monoxide sensor 402c, and carbon dioxide sensor 402d, as shown in FIG. 3. The one or more sensors 402 can be programmed or installed to sense inputs related to various potential attributes of the fire, fire indicators, or hazard and send the inputs to the fire control panel system 400. The fire control panel system 400 can include one or more sensors 402 such as a gas sensor, temperature sensor, infrared sensor, thermal sensor, or any combination thereof. The fire control panel system 400 can receive a unique device ID (e.g., an identification number, an identification code, etc.) from each of the one or more sensors or detectors. The one or more sensors 402 can determine a location of the premise based on the unique device ID. The fire control panel system 400 can include a location sensor to determine a location of the premise where fire is detected.

The smoke detector 402a, heat detector 402b, carbon monoxide sensor 402c, and carbon dioxide sensor 402d can be mounted inside the fire control panel system 400 and/or outside the fire control panel system 400. The smoke detector 402a, heat detector 402b, carbon monoxide sensor 402c, and carbon dioxide sensor 402d can be communicatively coupled with the fire control panel system 400, such as to perform wired and/or wireless communications with the fire control panel system 400.

The smoke detector 402a can detect smoke at a predetermined frequency, such as twice in a minute. The detected smoke data may be sent to the fire control panel system 400. The heat detector 402b can detect heat or temperature at a predetermined frequency, such as twice in a minute. The detected heat or temperature data may be sent to the fire control panel system 400. The heat or temperature may be measured in any unit such as degree Fahrenheit or Celsius.

The carbon monoxide sensor 402c and carbon dioxide sensor 402d detect carbon monoxide gas and carbon dioxide gas, respectively, at a predetermined frequency, such as twice in a minute. The detected gas data may be sent to the fire control panel system 400.

The fire control panel system 400 can include at least one alarm 405 (e.g., audio and/or visual indicator, such as an alarm bell and/or alarm light). The fire control panel system 400 can provide notifications via alarm bell in case any fire, fire indicators, or hazards are detected. The fire control panel system 400 can provide any visual notifications in case any fire, fire indicators, or hazards are detected.

The fire control panel system 400 can include one or more pull stations (not shown). The fire control panel system 400 can receive a unique pull station ID (e.g., an identification number, an identification name, a unique ID code, etc.) from each of the one or more pull stations. The fire control panel system 400 can perform a fire detection process based on any of the one or more pull stations (e.g., responsive to receiving a pull signal from operation of the one or more respective pull stations). The fire control panel system 400 can determine a location of a fire based on the received pull station IDs from the one or more pull stations.

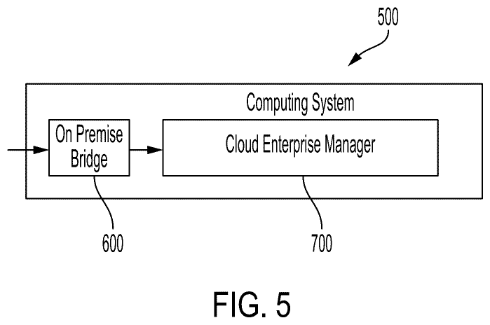

FIG. 5 depicts an example of a computing system 500 is described. The computing system 500 can include an on-premise bridge 600 and a cloud enterprise manager 700.

The on-premise bridge 600 can provide edge computing capabilities. Edge computing, can include the implementation, coordination, and use of computing and resources at locations closer to the “edge” or collection of “edges” of a network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by a system architecture or ad hoc service. Edge computing is also expected to be closely integrated with existing use cases and technology developed for IoT and Fog/distributed networking configurations, as endpoint devices, clients, and gateways attempt to access network resources and applications at locations closer to the edge of the network.

The on-premise bridge 600 can be one of a designated edge node server, an enterprise server, a roadside server, or a local or peer at-the-edge device, or any combination thereof. The on-premise bridge 600 can provide or host a cloud-like distributed service, to offer orchestration and management for applications and coordinated service instances among many types of storage and compute resources.

The on-premise bridge 600 may include one or more processors. one or more processors, memory, speakers, and/or microphone (not shown). The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The on-premise bridge 600 can include a memory. The memory can include any computer-readable storage medium, for example, volatile memory, random access memory (RAM), non-volatile memory, read only memory (ROM), or flash memory. The memory may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The on-premise bridge 600 can receive a signal from the fire control panel system 400. The signal can allow the on-premise bridge 600 to determine whether a fire is detected in the premise or not. Responsive to detecting the fire, the on-premise bridge 600 can activate the image capture system 300. Subsequent to activation, the image capture system 300 can acquire image data of the fire using the image acquisition device 301.

The flame detector 302 can run any of various flame detection algorithms on the acquired image data to detect an area of flame of the fire. The image capture system 300 can send the acquired image data and the detected flame area to the on-premise bridge 600 for further analysis. For example, the on-premise bridge 600 can perform an edge detection on the received image data and the detected flame area. The edge detection can be performed to accurate identify whether the fire is hazardous or non-hazardous. Responsive to the area of the flame being greater than a predetermined flame area, the on-premise bridge 600 can determine the fire to be hazardous. Responsive to the area of the flame being less than the predetermined flame area, the on-premise bridge 600 can determine the fire to be non-hazardous.

The on-premise bridge 600 (and/or flame detector 302) can determine the fire to be hazardous (or not hazardous) responsive to the area of the flame being greater than the threshold and according to one or more factors being satisfied, such as based on a size metric of the flame such as a length of the flame, an intensity of the flame, a duration of the flame, or various combinations thereof. As discussed with respect to the flame detector 302, the on-premise bridge 600 and/or the flame detector 302 can include one or more machine learning models trained to classify image data indicative of hazardous or non-hazardous fires.

Subsequent to detecting that the fire is hazardous, the on-premise bridge 600 can activate the extinguisher system 200 to extinguish or suppress the fire. The on-premise bridge 600 can activate the alarm 405 of the fire control panel system 400 to notify one or more users. The on-premise bridge 600 is in communication with the cloud enterprise manager 700. The on-premise bridge 600 also notifies the cloud enterprise manager 700 about the hazardous fire.

The cloud enterprise manager 700 provides cloud computing capabilities. The cloud enterprise manager 700 can include a one or more applications, middleware and/or database service offerings that are delivered to a customer in a self-service, subscription-based, elastically scalable, reliable, highly available, and secure manner. The cloud enterprise manager 700 may host an application and a user may, via a communication network such as the Internet, on demand, order and use the application.

The cloud enterprise manager 700 can establish a workflow in case the fire is hazardous. The workflow may comprise instructions or actions to be followed for one or more users, building workers, area managers, and/or first responders. The workflow can include evacuation route to be followed in case of hazardous fire. The workflow can include measures to be taken in case of hazardous fire. The cloud enterprise manager 700 can present the workflow in a visual form via form via one or more of charts, dashboards, table, any suitable form, or any combination thereof. The cloud enterprise manager 700 can monitor status of each of the instructions or actions of the workflow. The cloud enterprise manager 700 can flag any anomaly in the status of each of the instructions or actions of the workflow.

The cloud enterprise manager 700 can escalate an event of the hazardous fire at different levels of authority. For example, the cloud enterprise manager 700 may escalate the event of hazardous fire to the building workers. In case there is no response from the building workers, the cloud enterprise manager 700 may escalate the event of hazardous fire to an area manager with a higher authority compared to the building workers. The escalations may comprise sending notifications or emails to at least one of building workers, area managers, superintendents, or any suitable entity or any person of suitable authority. The notifications may be provide via SMS, email, visual notifications, audio notifications, or any combination thereof. The notifications may be sent to plurality of managers each having different authority levels.

The cloud enterprise manager 700 maintains information about the extinguisher system 200, the image capture system 300, and the fire control panel system 400 in a database. The information comprises location information, user manuals, manufacturing details, details of expiration. The cloud enterprise manager 700 can maintain real-time status and real time readings of extinguisher system 200, the image capture system 300, and the fire control panel system 400. The cloud enterprise manager 700 can present the information in a visual form via one or more of charts, dashboards, tables, or any combination thereof.

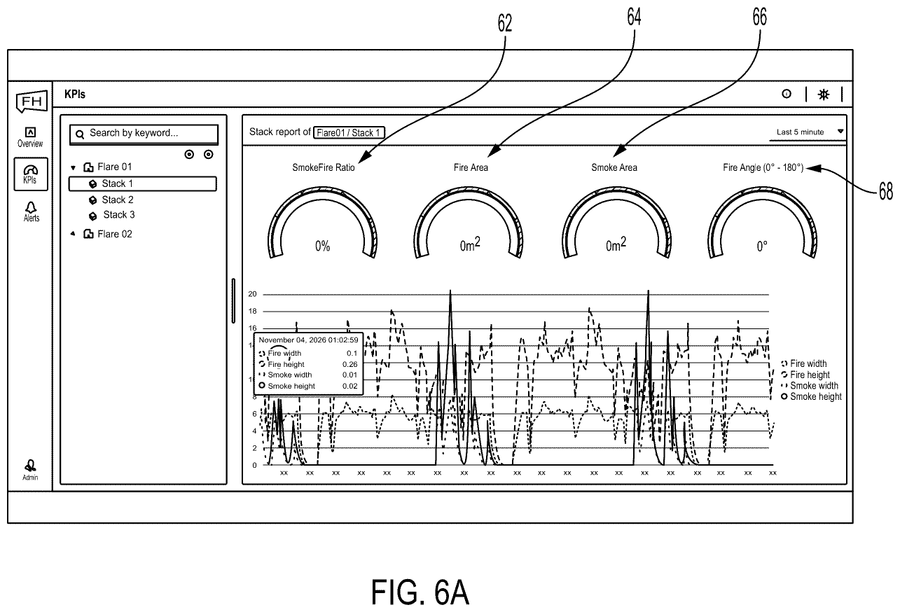

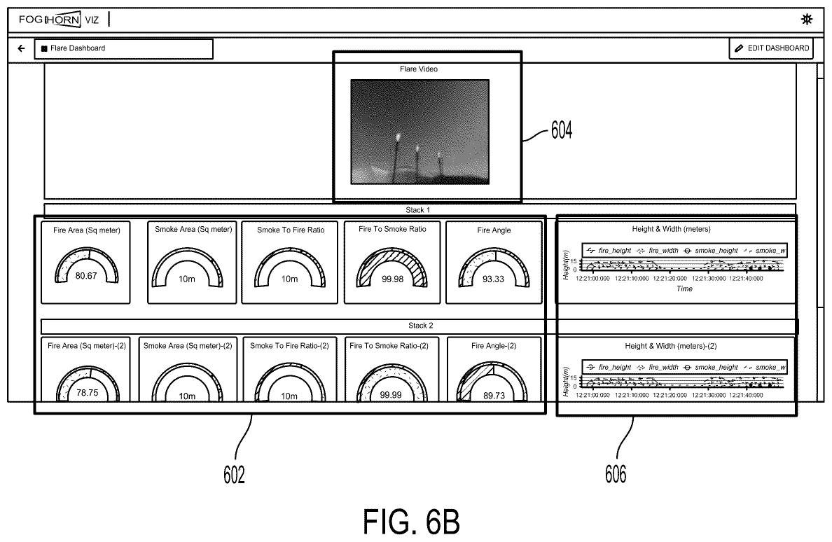

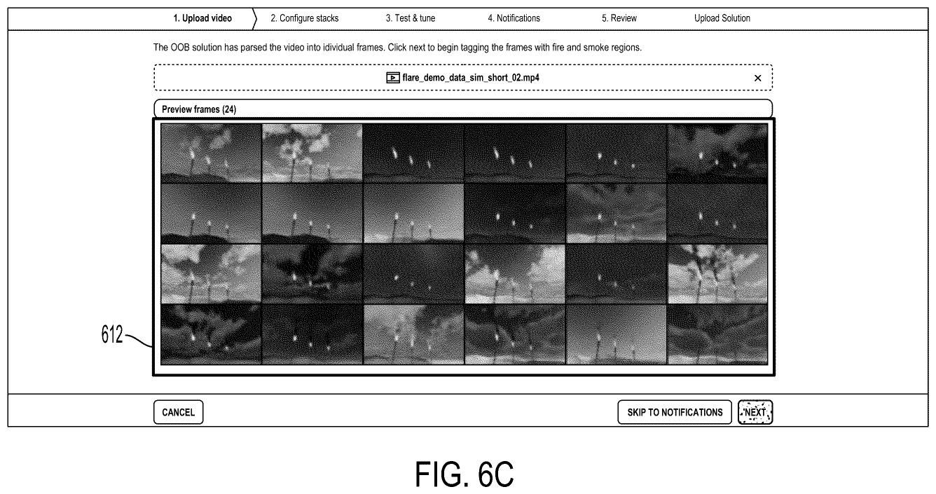

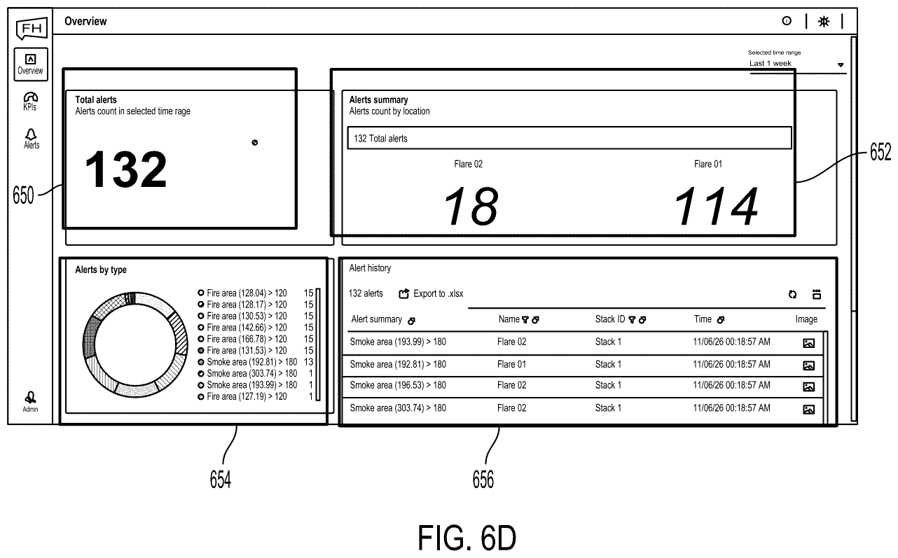

The cloud enterprise manager 700 can host user configurable real time dashboards for the FDSS 100, such as depicted in the examples of FIGS. 6A, 6B, 6C, and 6D of user configurable real time dashboards provided by the cloud enterprise manager 700.

The dashboard of FIG. 6A includes a graphical relation between smoke fire ratio 62, fire area 64, smoke area 66, and/or fire angle 68 of a fire in the premise. The dashboard of FIG. 6B can be a user configurable real time dashboard that presents a visual stack 602 that includes a visual representation of fire area, smoke area, smoke to fire ratio, fire to smoke ratio, fire angle, fire area, smoke area, and/or fire angle, of the fire in the premise. The dashboard of FIG. 6B can include a flame video representation 604 and graphical representation 606 of flame height and width ratio of a flame of a fire. FIG. 6C depicts a user configurable real time dashboard that presents pictorial representation 612 of a fire area and a smoke area of the fire. FIG. 6D depicts a user configurable real time dashboard that shows an alert summary comprising total alerts 650, an alert count by location 652, an alert count by type 654, and a history of alerts 656.

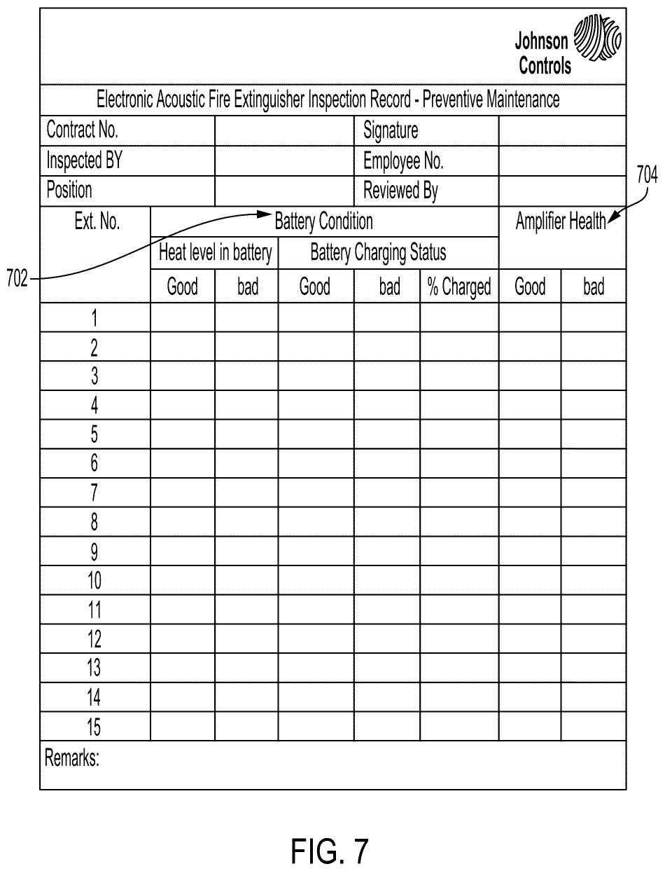

The cloud enterprise manager 700 can use artificial intelligence and/or machine learning models to enhance the performance of the FDSS 100. The cloud enterprise manager 700 can track the health of the FDSS 100. FIG. 7 depicts a user configurable real time dashboard that presents a health summary of the FDSS 100 based on the health tracked by the cloud enterprise manager 700. The health summary can include for example, but not limited to, battery condition 702 and amplifier health 704.

The computing system 500 can maintain information regarding a plurality of FDSSs 100. The computing system 500 can maintain location information, user manuals, manufacturing details, details of expiration, real-time status, and/or real time readings about the plurality of FDSSs 100. The computing system 500 can remotely control the plurality of FDSSs 100. The computing system 500 can predict any anomaly, including but not limited to anomalies associated with fire conditions or hazardous fires or operation of the FDSS 100, in at least one of the plurality of FDSSs 100. The computing system 500 can perform measures for the maintenance of at least one of the plurality of FDSSs 100. The computing system 500 can present the information about the plurality of FDSSs 100 in a visual form via one or more of charts, dashboards, table, any suitable form, or any combination thereof.

The computing system 500 may include one or more processors. one or more processors, memory, speakers, and/or microphone (not shown). The processor can include a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

Tthe computing system 500 may include a memory. The memory can include any computer-readable storage medium, for example, volatile memory, random access memory (RAM), non-volatile memory, read only memory (ROM), or flash memory. The memory may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

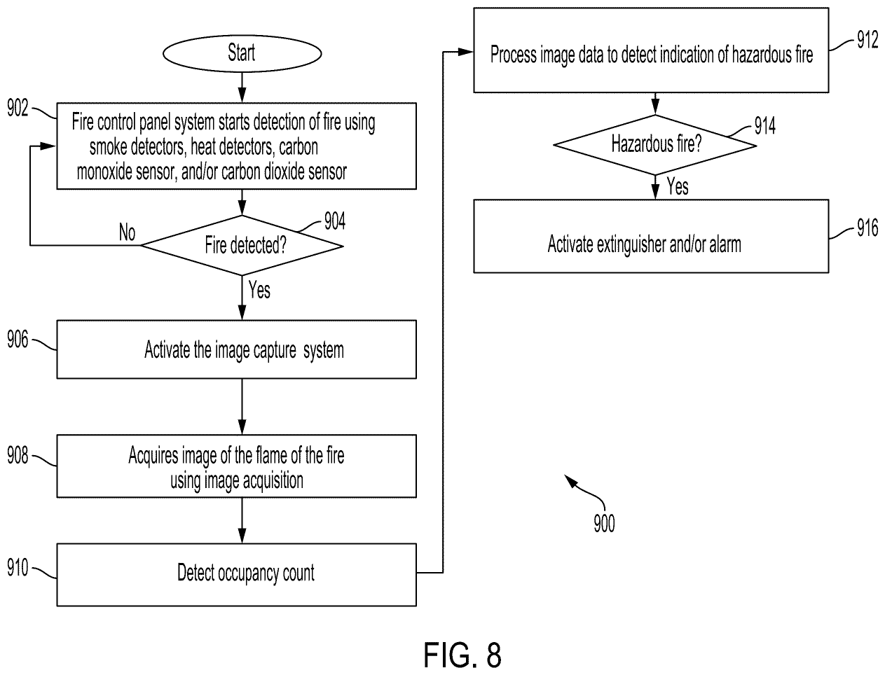

FIG. 8 depicts an example of a method 900. The method 900 can be performed using any of various systems or devices described herein, such as for operation of the FDSS 100. The method 900 can be performed to trigger alerting of a hazardous fire and/or addressing or suppressing the hazardous fire responsive to determining that data regarding a premise (e.g., image data of a commercial kitchen) meets one or more criteria for representing a hazardous fire. While various operations of the method 900 are described with reference to components of the FDSS 100, such operations may be performed by other components of the FDSS 100 according to factors including but not limited to location, computational resource usage, and/or network latency.

At 902, a fire can be detected or otherwise identified by a fire control panel system (e.g., fire control panel system 400), such as responsive to receiving sensor data from one or more sensors. For example, any one or more sensors (e.g., the smoke detectors 402a, heat detectors 402b, carbon monoxide sensor 402c, or/and carbon dioxide sensor 402d) can detect any potential attributes of a fire, fire indicators, or a hazard in a premise. The output of the one or more sensors (e.g., of one or more of the smoke detectors 402a, heat detectors 402b, carbon monoxide sensor 402c, or/and carbon dioxide sensor 402d) can be transmitted to the fire control panel system as a first control signal. The fire control panel system can transmit the received first control signal to an on-premise bridge (e.g., on-premise bridge 600).

At 904, the first control signal can be processed (e.g., by the on-premise bridge 600) to determine that there is a fire according to the first control signal. For example, a flag or other indicator indicating that a fire is present can be identified from the first control signal and/or the first control signal can include sensor data indicative of a fire that the on-premise bridge manager can process to determine that the fire is present.

Responsive to determining that the fire is present, at 906, an image capture system (e.g., the image capture system 300) can be activated, such as to be caused to capture one or more images. For example, the on-premise bridge 600 can a second control signal to the image capture system 300 responsive to determining that the fire is present to cause the image capture system 300 to capture the one or more images.

At 908, the image capture system can capture the one or more images of the flame of the fire (e.g., using the image acquisition device 301). The image capture system can process the acquired image data of the flame of the fire (e.g., using the flame detector 302) to determine one or more characteristics of the flame, including but not limited to a size metric of the flame, such as at least one of an area or a length of the flame.

At 910, an occupancy count (e.g., count of people) can be detected by processing the one or more images, such as by using the occupancy counter 304. The occupancy count can be periodically detected, such as to be updated on a periodic basis, including while the image capture system is activated responsive to the detection of the fire.

At 912, various computer vision operations, such as edge detection, can be performed on the image data to determine whether the fire is a hazardous fire or non-hazardous fire (e.g., according to one or more criteria regarding the fire). The edge detection (or other computer vision operations described with reference to flame detector 302) can include detecting one or more edges of the flame to determine a size metric of the flame. Responsive to determining the size metric, the determined size metric of the flame (e.g., flame area) can be compared with a predetermined size metric (e.g., predetermined flame area). The size metric can be indicative of an expected size of a cooking flame, such that the fire is not determined to be hazardous unless it is determined that the fire is different (e.g., larger) than a cooking flame. Responsive to the determined flame area being less than the predetermined flame area, the fire can be determined to be non-hazardous. Responsive to the determined flame area being greater than the predetermined flame area, the fire can be determined to be hazardous. The edge detection can be performed according to a duration of the flame in addition to the flame area. For example, responsive to the determined flame area being greater than the predetermined flame area and the duration of the flame being more than a predetermined duration, the fire can be determined to be hazardous, otherwise non-hazardous. The predetermined duration may be a user defined duration. By incorporating characteristics such as duration along with the size metric (and/or additional characteristics such as temperature or color), the flame can be more accurately classified as hazardous or non-hazardous in order to more accurately trigger operations such as activating an extinguisher and/or an alarm, including in situations where useful flames may often be present, such as in commercial kitchens.

The one or more images can be periodically evaluated to determine whether the fire meets the at least one criteria of being hazardous while in a period of the indication of the fire being received. For example, responsive to receiving the indication of the fire, the one or more images can be processed until a timer expires, the time being incremented from the time of receiving the indication (the timer can be reset responsive to receiving a second and/or continued indication), such as to continually monitor the premise for the potential of the fire to become hazardous. The image capture system can be deactivated or otherwise caused to discontinue image capture responsive to the timer expiring.

At 916, responsive to determining that the fire is hazardous, at least one of a fire suppression operation or an alarm operation can be triggered. For example, the on-premise bridge 600 can activate an extinguisher system (e.g., extinguisher system 200) responsive to the determining that the fire is a hazardous fire. The extinguisher system can activate, for example, a fire extinguishing or suppression device such as a sound generator (e.g., trigger operation of the sound frequency generator 208 via the controller 206). The sound generator can generate a sound frequency wave to suppress or extinguish the fire. The extinguisher system may suppress or extinguish the fire using the sound frequency generator and/or any of various devices described herein, for example, but not limited to, devices that output foam deluge, water, pressurized gas.

An alarm can be activated (e.g., alarm 405 of the fire control panel system 400) to provide a notification to one or more users regarding the hazardous fire. The alarm can include at least one of a visual output or audio output. The notification may be provided via one or more of SMS, email, visual notifications, audio notifications, or any combination thereof.

The on-premise bridge 600 can continually perform the monitoring of the occupancy count during various conditions, such as during a period after determination that the fire is a hazardous fire and/or while people are determined to be present in the premise subsequent to determining that the fire is a hazardous fire. Responsive to determining that the count of people in the premise having the hazardous fire is greater than a predetermined threshold, the alarm can be activated to notify one or more users in the premise about the hazardous fire. The on-premise bridge 600 can transmit visual notifications to the one or more users in the premise. The on-premise bridge 600 can transmit the notifications at frequent intervals unless the premise is evacuated (e.g., the occupancy count is determined to be zero, such as for at least a predetermined duration). The on-premise bridge 600 can transmit instructions to be followed by the one or more users to evacuate the premise.

The on-premise bridge 600 may send the output of the edge detection, fire detection, and/or hazardous fire determination to a remote device, such as to the cloud enterprise manager 700. The cloud enterprise manager 700 may receive the output and may present user configurable real time dashboards based on the received output. The cloud enterprise manager 700 may also store the received output in a database. The cloud enterprise manager 700 may perform analysis on the received output using artificial intelligence and machine learning models.

Referring further to FIG. 1, the FDSS 100 can perform various edge computing capabilities provided by the computing system 500 to accurately identify hazardous fires. The disclosed FDSS 100 uses both the one or more sensors or detectors and the edge computing capabilities to accurately differentiate and identify the hazardous fire from the non-hazardous fire. The FDSS 100 can take steps to suppress or extinguish the hazardous fire. Thus, the disclosed FDSS 100 can provide efficient, reliable, accurate, and hazardous fire detection, thereby, preventing false alarms or nuisance alarms.

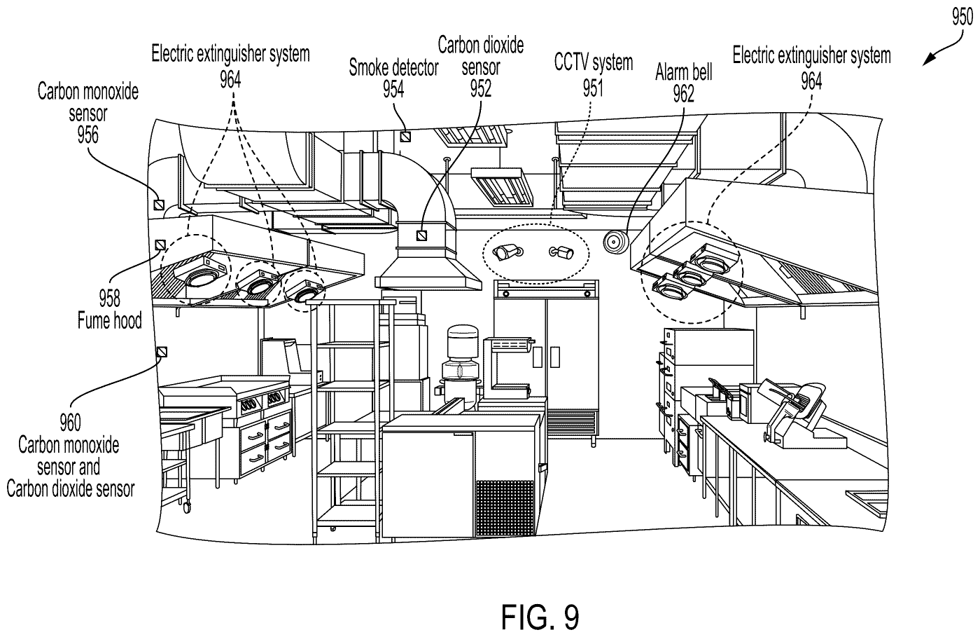

FIG. 9 depicts an example of the FDSS 100. FIG. 9 illustrates an example system 950 where some of the components of FDSS 100 are installed and implemented in a kitchen. The system 950 includes CCTV system 951, carbon dioxide sensor 952, smoke detector 954, carbon monoxide sensor 956, fume hood 958, carbon monoxide sensor and carbon dioxide sensor 960, alarm bell 962, and electric extinguisher system 964. One or more heat sensors (not shown) are installed inside the fume hood 958. The electric extinguisher system 964 may include a plurality of extinguishers configured to suppress or extinguish hazardous fire. The system 950 is an example illustration and is not limited. The system 950 may be modified with the additional components or devices described herein.

The disclosed FDSS 100 may be implemented in residential or commercial applications, for example, but not limited to, commercial kitchens, residential kitchens, commercial buildings, residential buildings, electric vehicles, hospitals, restaurants, hotels, corporate offices, public malls, airports, railway stations, schools, or any other suitable application.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act, or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical, or other positioning or orientation descriptions include variations within +/−10% or +/−10 degrees of pure vertical, parallel, or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “of” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A fire suppression system, comprising:
an image capture device to detect one or more images of a premise;
an extinguisher; and
one or more processors to:
receive an indication of a fire in the premise;
process, responsive to the indication of the fire, the one or more images to determine that the fire meets at least one criteria of being hazardous; and
activate the extinguisher responsive to the determination that the fire meets the at least one criteria.

2. The fire suppression system of claim 1, comprising:
the at least one criteria comprises at least one of an area of a flame of the fire, a length of the flame, and a duration of the flame.

3. The fire suppression system of claim 1, comprising:
the one or more processors are to provide the one or more images as input to at least one neural network to determine that the fire meets the at least one criteria, the at least one neural network trained with image data indicative of fire and assigned a label of the respective fire being hazardous or not being hazardous.

4. The fire suppression system of claim 1, comprising:
the at least one criteria are represented by at least one machine learning model, the one or more processors to determine that the fire meets the at least one criteria responsive to processing the image data using the at least one machine learning model.

5. The fire suppression system of claim 1, comprising:
the one or more processors are to:
periodically process the one or more images to determine an occupancy count of the premise; and
cause an alarm to be activated at least while the occupancy count is greater than zero and the fire is determined to be hazardous.

6. The fire suppression system of claim 1, comprising:
the one or more processors are to cause the image capture device to detect the one or more images responsive to the indication of the fire.

7. The fire suppression system of claim 1, comprising:
a fire control panel to provide the indication of the fire to the one or more processors responsive to receiving a sensor signal corresponding to the fire from at least one of a smoke detector, a heat detector, a carbon monoxide sensor, or a carbon dioxide sensor.

8. The fire suppression system of claim 1, comprising:
the one or more processors are to periodically evaluate the one or more images to determine whether the fire meets the at least one criteria of being hazardous while in a period of the indication of the fire being received.

9. The fire suppression system of claim 1, comprising:
the at least one criteria correspond to a threshold size of the fire, the threshold size representing an expected size of a cooking flame.

10. The fire suppression system of claim 1, comprising:
the one or more processors are to activate an alarm responsive to determining that the fire meets the at least one criteria.

11. The fire suppression system of claim 1, comprising:
the extinguisher comprises a sound generator to output a sound having at least one frequency to suppress or extinguish the fire.

12. The fire suppression system of claim 1, comprising:
the premise comprises a kitchen.

13. A system, comprising:
one or more processors to:
sample a signal from a fire control panel to identify an indication of a fire in a premise;
activate, responsive to the indication of the fire, an image capture device to retrieve one or more images of the premise;
classify, according to the one or more images, the fire as being hazardous; and
activate at least one of an extinguisher or an alarm responsive to the classification of the fire as being hazardous.

14. The system of claim 13, comprising:
the one or more processors are to classify the fire as being hazardous based on at least one of an area of a flame of the fire, a length of the flame, and a duration of the flame.

15. The system of claim 13, comprising:
the one or more processors are to provide the one or more images as input to at least one neural network to classify the fire as being hazardous, the at least one neural network trained with image data indicative of fire and assigned a label of the respective fire being hazardous or not being hazardous.

16. The system of claim 13, comprising:
the one or more processors are to:
periodically process the one or more images to determine an occupancy count of the premise; and
cause the alarm to be activated at least while the occupancy count is greater than zero and the fire is classified as hazardous.

17. A method, comprising:
sampling, by one or more processors, a signal from a fire control panel to identify an indication of a fire in a premise;
activating, by the one or more processors responsive to receiving the indication of the fire, an image capture device to retrieve one or more images of the premise;
classifying, by the one or more processors according to the one or more images, the fire as being hazardous; and
activating, by the one or more processors, at least one of an extinguisher or an alarm responsive to classifying the fire as being hazardous.

18. The method of claim 17, comprising:
classifying, by the one or more processors, the fire as being hazardous based on at least one of an area of a flame of the fire, a length of the flame, and a duration of the flame.

19. The method of claim 17, comprising:
providing, by the one or more processors, the one or more images as input to at least one neural network to classify the fire as being hazardous, the at least one neural network trained with image data indicative of fire and assigned a label of the respective fire being hazardous or not being hazardous.

20. The method of claim 17, comprising:
periodically processing, by the one or more processors, the one or more images to determine an occupancy count of the premise; and
causing, by the one or more processors, the alarm to be activated at least while the occupancy count is greater than zero and the fire is classified as hazardous.
